(19) United States
(12) Patent Application Publication
(10) Pub. No.: US 2011/0044512 A1
(43) Pub. Date: Feb. 24, 2011

(54) Automatic Image Tagging

(75) Inventors: Manik Bambha, Agoura Hills, CA (US); Thomas Anderson, Beverly Hills, CA (US); Steven Pearman, Los Angeles, CA (US); Vincent Roussilhon, San Francisco, CA (US)

Correspondence Address: Cantor Colburn LLP - Fox Entertainment Group, 20 Church Street, 22nd Floor, Hartford, CT, 06103, US

(73) Assignee: MYSPACE INC., Beverly Hills, CA (US)

(21) Appl. No.: 12/752,099

(22) Filed: Mar. 31, 2010

Related U.S. Application Data
(60) Provisional application No. 61/165,127, filed on Mar. 31, 2009.
(60) Provisional application No. 61/165,120, filed on Mar. 31, 2009.

(51) Int. Cl. G06K 9/00; G09G 5/00; G06F 15/16

(52) U.S. Cl. 382/118; 345/620; 709/217

(57) ABSTRACT

A method of automatic tagging of images on an image hosting website includes receiving at least one image, locating faces and/or people in the received image, recognizing features of the located faces and/or people, and automatically tagging the located faces and/or people in response to the recognizing.

### CROSS REFERENCE TO RELATED APPLICATIONS

This application claims priority under 35 U.S.C. §119 to U.S. Provisional Application No. 61/165127 filed Mar. 31, 2009 and to U.S. Provisional Application No. 61/165120 filed Mar. 31, 2009; there entire contents of both Provisional Applications are hereby incorporated by reference in their entirety.

### TECHNICAL FIELD

The present invention is generally related to social networking and/or image hosting websites. More particularly, example embodiments of the present invention are directed to the automatic tagging of (or insertion of meta-data in) photos uploaded by users of a social networking and/or image hosting website through the use of facial recognition.

### BACKGROUND OF THE INVENTION

Conventionally, users within a social networking and/or image hosting website upload images for other users to view. It is often useful to tag a photo with the names/ID of other users such that familiar people within photos may be searched quickly. However, conventional means for tagging involves a user uploading a photo, identifying particular individuals, determining that individual's identification manually, and inserting the tags singularly.

### BRIEF DESCRIPTION OF THE INVENTION

According to example embodiments, a method of automatic tagging of images on an image hosting website includes receiving at least one image, locating faces and/or people in the received image, recognizing features of the located faces and/or people, and automatically tagging the located faces and/or people in response to the recognizing.

According to example embodiments, a system of automatic tagging of images on an image hosting website includes a user terminal, the image hosting website in operative communication with the user terminal, the image hosting website disposed to receive images uploaded from the user terminal. The system further includes a recognition server in operative communication with the image hosting website, the recognition server disposed to receive images from the image hosting website and to process and automatically tag the received images. The system further includes an image upload server in operative communication with the image hosting website, the image upload server disposed to store automatically tagged images received from the image hosting website.

According to example embodiments, a computer readable storage medium contains computer executable instructions that, if executed by a computer processor of a computer apparatus, direct the computer processor to implement a method of automatic tagging of images on an image hosting website. The method includes receiving at least one image, locating faces and/or people in the received image, recognizing features of the located faces and/or people, and automatically tagging the located faces and/or people in response to the recognizing.

These and other features of the present invention will be better appreciated by reference to the appended drawings and the description which follows.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. Furthermore, each drawing contained in this provisional application includes at least a brief description thereon and associated text labels further describing associated details. The figures:

FIG. 1 illustrates an image with identified faces for automatic tagging;

FIG. 2 illustrates a system for automatic tagging of photographs/images, according to an example embodiment;

FIG. 3 illustrates an example server system for feature/facial recognition, according to an example embodiment;

FIG. 4 illustrates a methodology for generating a facial identification record, according to an example embodiment;

FIG. 5 illustrates a methodology for distribution of facial recognition workloads, according to an example embodiment;

FIG. 6 illustrates a detailed methodology for automatic tagging of photographs/images, according to an example embodiment;

FIG. 7 illustrates a database organization scheme for automatic tagging of photographs/images, according to an example embodiment;

FIG. 8 illustrates a methodology for automatic tagging of photographs/images, according to an example embodiment; and

FIG. 9 illustrates a computer apparatus, for example, as may be utilized by any user as described herein or to implement any methodology used herein.

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

It will further be understood that the terms “photo,” “photograph,” and/or “image” including any variations thereof may be used interchangeably herein without departing from the scope of example embodiments. For example, although some example embodiments may be described with reference to a photograph, it should be understood that the same may be applicable to any image, and vice versa.

Additionally, the terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Further to the brief description provided above and associated textual detail of each of the figures, the following description provides additional details of example embodiments of the present invention.

Example embodiments are directed to methods of utilizing facial/feature recognition to implement an automatic tagging base for images of an image owner on an image hosting website. For example, as an image owner “tags” or establishes data or meta-data for different image items (e.g., people/places/things) within a set of images, features associated with said image items may be automatically identified in future images through facial/feature recognition. Upon realization of a previously tagged image item, said image item may be automatically tagged with a previously used description or tag. Through automatic tagging of newly added images and/or existing images, an owner's image set may be more easily indexed and organized. For example, all images including the owner may have tags associating the owner as a participant in the image automatically appended thereon.

Facial recognition may aid a user tagging photos by identifying faces on the photo and matching them with the previously tagged photographs. This feature may be an extension of the tagging feature. For example, it may be accessed every time it is possible to tag photos. According to one example implementation, two different use cases around facial recognition may be used. According to one use, a user uploads photos and lands on a Captions or photo summary interface. The user may subsequently choose a tagging option from within the interface. Through processing the photographs, for each photograph the following information may become available: number of faces; position of each face; specific attributes of each face (used for matching faces); number of males/females; number of children/babies; ethnicity of people; people wearing glasses/goggles; and/or any other suitable information retrieved through the processing.

The processing of uploaded photos may be launched during the uploading process. It may be desirable to perform processing in parallel to the uploading/resizing such that it does not increase the uploading time. To save resources, the processing may occur after thumbnails have been created and may be applied to a large size thumbnail (e.g., 600 px width) instead of the original (for example, if originally sized images are not stored on the image-hosting website).

With regards to existing photos, if a user signs on for the feature to process old photos, a processor may begin to gradually process all existing photos already hosted on the image hosting website if prior tags have not been established within the older photos. The newest photos may be processed first, with older photos afterward. In this manner, older content that is less used will be processed later.

A previously tagged photo album contains photos tagged with the user name and approval status by the user owning the photo album. Training data may be created for users who have a tagged photo album with more than “n” photos, with “n” representing a predetermined or desired threshold. For example, “n” may represent a minimum number of photographs suited to provide a good or desirable training data set.

Automatic tagging may be initiated by a user through a provided interface, or may be deselected if a user prefers manual tagging. In at least one example embodiment, a combination of automatic and manual tagging may be used as well. For example, a user may be provided with automatically generated tags or recommendations, and a user may manually correct or choose new tags. In this manner, an increased data set may be created to further enhance automatic tagging.

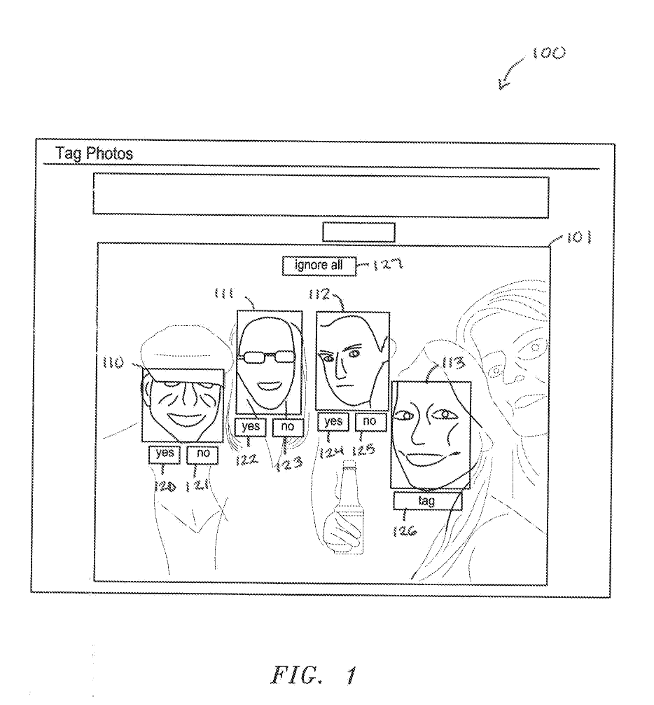

Turning to FIG. 1, a photograph with identified faces for tagging is illustrated. The individual faces have been “boxed” for identification as items automatically deemed available for tagging. In an alternate implementation, a user may select the individual faces for desired tagging. During the uploading process, or at significantly the same time, image processing may be executed of an uploaded image 101. Individual faces/people (110, 111, 112, and 113) may be processed individually or in parallel. As different features (e.g., as noted in examples above) are identified, the different features may be compared to previously uploaded, tagged images for the user.

For example, any of the faces 110-113 may be matched to existing, tagged images for the uploading user. The user may be prompted through user interface elements 120-127 to automatically tag or manually tag each face 110-113.

Although described in terms of automatic tagging, it should be understood that other implementations of example embodiments may utilize facial feature recognition resources to match identified faces to any database. For example, the facial features identified for faces 110-113 may be compared to any image database in operative communication with a server including the uploaded image. For example, any one of the faces 110-113 may be matched, using facial feature recognition, to images contained in a law enforcement database. Thereafter, an appropriate or suitable action may be taken. For example, a user's account may be modified, suspended, or otherwise halted. Also, or additionally, a report may be issued and the user may be notified of the match from the uploaded image.

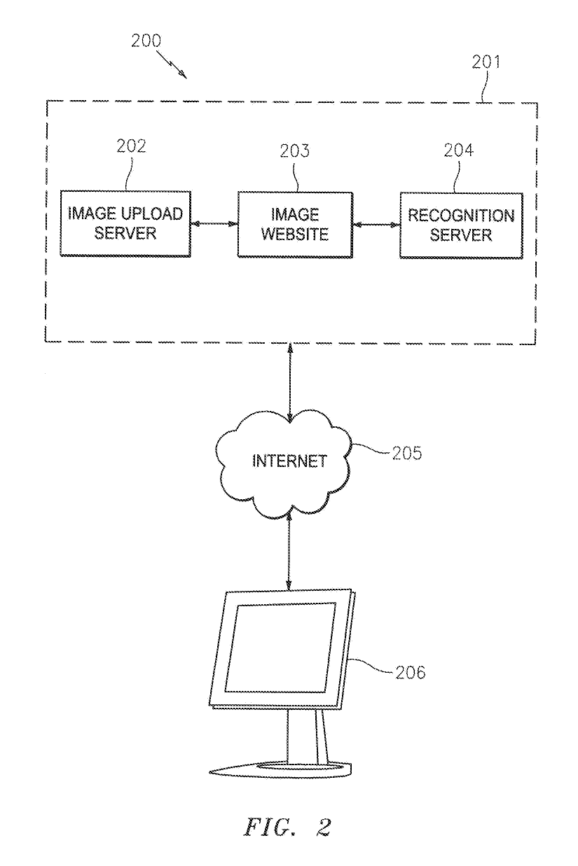

FIG. 2 illustrates a system for automatic tagging of photographs/images, according to an example embodiment. The system 200 may include a user device 206. The user device 206 may include any device suitable for uploading photographs to a social networking/image hosting website. The system further includes an image processing group 201 in communication with the user device 206 through a network 205, for example the Internet. The image processing group 201 may include an image upload server 202, the social networking/image hosting website 203, and a recognition server portion 204. Each portion of the image processing group 201 may be in direct or indirect communication through any suitable means. For example, a user of the user device 206 may upload a photograph to the image processing group 201. The image processing group 201 may subsequently process the uploaded photograph and provide automatic tagging of portions therein.

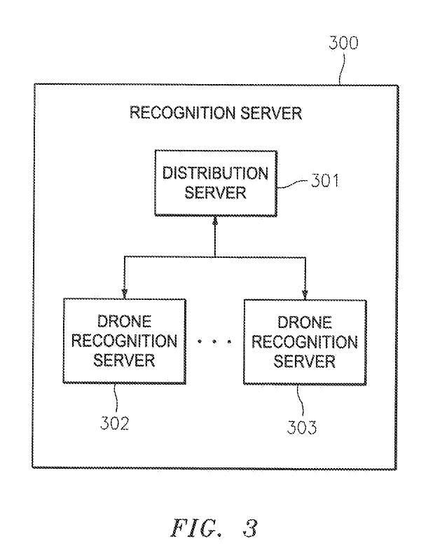

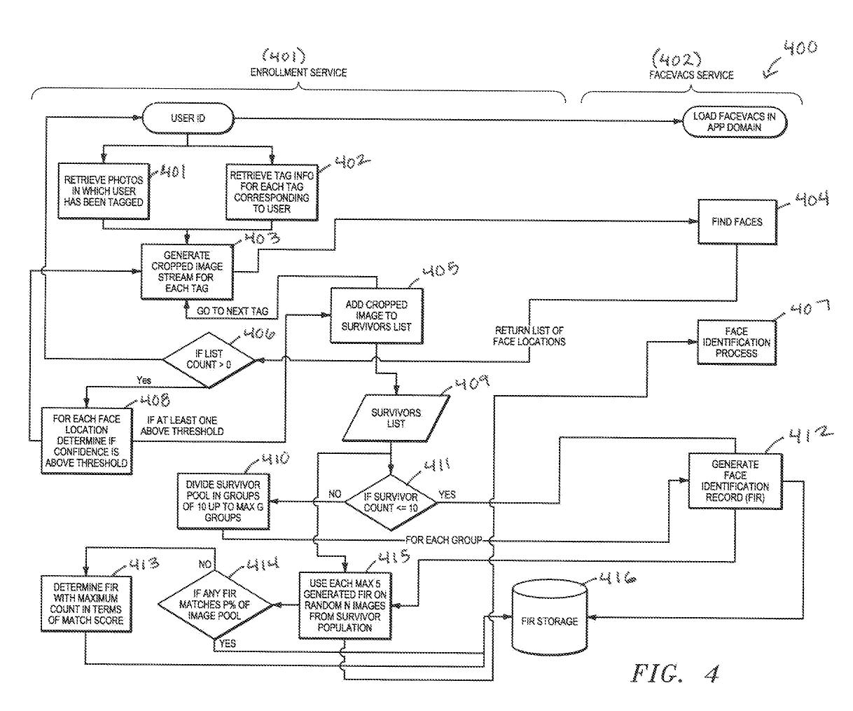

FIG. 3 illustrates an example server system for feature/facial recognition, for example, as represented in recognition server portion 204 of FIG. 2. The example server system 300 may include at least one distribution server 301, and a plurality of drone recognition servers 302-303. For example, the distribution server 301 may determine workloads for each drone server of the plurality of drone servers 302-303, and may balance facial/feature recognition tasks among the plurality of drone recognition servers 302-303. Hereinafter, methodologies of example embodiments and storage elements for automatic tagging are described with reference to FIGS. 4-8.

FIG. 4 illustrates a methodology for generating a facial identification record (FIR), according to an example embodiment. As illustrated, the methodology includes a separation of tasks through an enrollment service 401 and a facial recognition service 402. As a user uploads photographs, the photographs are processed and facial identification records are created/verified for different people identified within the photograph.

For example, the method 400 includes retrieving photos in which a user has been tagged at block 401. The retrieving may include querying a database including meta-data associated with a plurality of photos, and retrieving photos including tags or meta-data associated with the user. The method 400 further includes retrieving tag information for each tag corresponding to a user at block 402.

Thereafter, the method 400 includes generating a cropped image stream for each tag at block 403. The cropped image stream may include the faces associated with the retrieved tags. The method 400 further includes finding faces within each cropped image stream at block 404.

Thereafter, if there are remaining photos (406), the method 400 includes retrieving the additional photos again at blocks 401-402. Otherwise, the method 400 includes determining if a feature recognition confidence is above a predetermined or desired threshold at block 408. If not, the method recreates cropped image streams at block 403. If the confidence is above the threshold, the method 400 includes adding the cropped image to a survivors listing at block 405. If the survivors list is sparsely populated (411), the method includes generating a facial identification record for the image at block 412 and storing the record in database 416. If the survivors list includes a relatively large number of survivors, the survivors list (individual faces/images) is divided into groups for easier processing at block 410. Thereafter, for each group, facial identification processing occurs (412). For each maximum scored facial identification record generated, taken from a random pool of survivors, if any record matches a desired percentage of the pool (414-415) it is stored in the database 416. Otherwise, the facial identification record with the maximum count in terms of a matching score (413) is stored in the database 416.

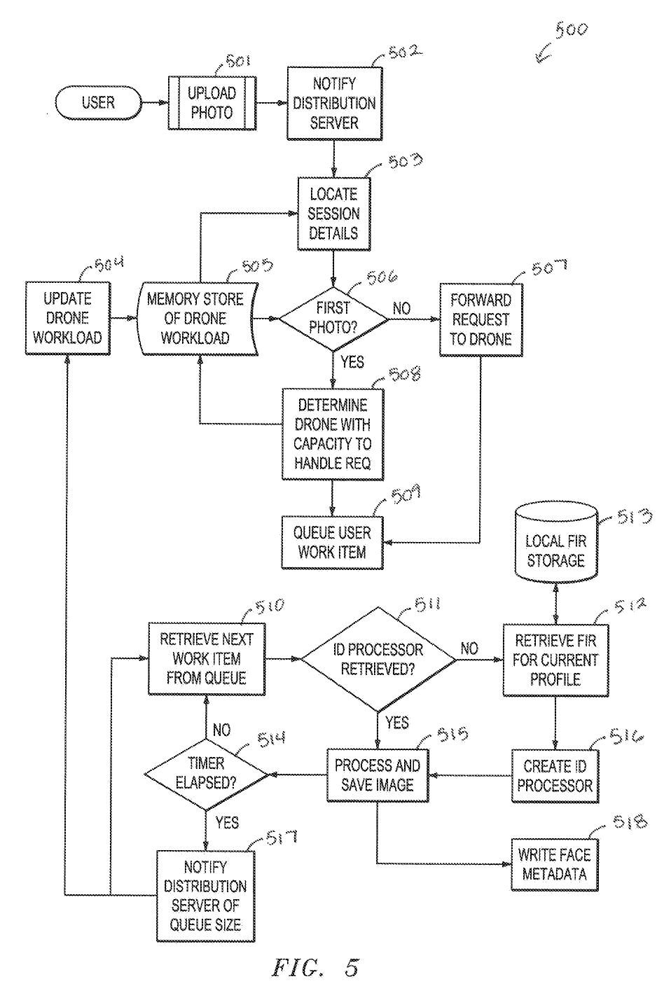

As noted above, facial recognition workloads may be distributed. FIG. 5 illustrates a methodology for distribution of facial recognition workloads, according to an example embodiment. As illustrated, a distribution server (see FIG. 2-3) is notified of uploaded photographs (501-502). Subsequently, drone recognition server capacity is determined/considered (503-508), and the uploaded photographs are processed with facial/feature recognition algorithms (510-517).

For example, the method 500 includes uploading a photo (501) and notifying the distribution server of the new upload (502). Thereafter, the method 500 includes locating session details at block 503. If the uploaded photo is the first of a series of photos, the drone capacity is determined to ensure it can handle the request at block 508. If the photo is not the first in a series, the request is forwarded to the drone at block 507, and the user work item (i.e., facial recognition of the photo) is queued at block 509. To facilitate the identification of the drone workload, the drone workload is updated regularly with block 504, and stored in accessible memory at block 505.

The method 500 further includes retrieving a work item from the drone queue at block 510. Thereafter, if a facial processor is identified (511), the image is processed at block 515. If a processor is not identified, the facial identification record is retrieved from local storage 513, and a facial processor is created at block 516. Thereafter, the image is processed at block 515.

During processing, a work timer is checked at regular intervals to determine if a predetermined or desired amount of processing time has lapsed (514). Using this determination, the drone workload may be updated (517) and new items from the drone's queue may be retrieved for processing at block 510.

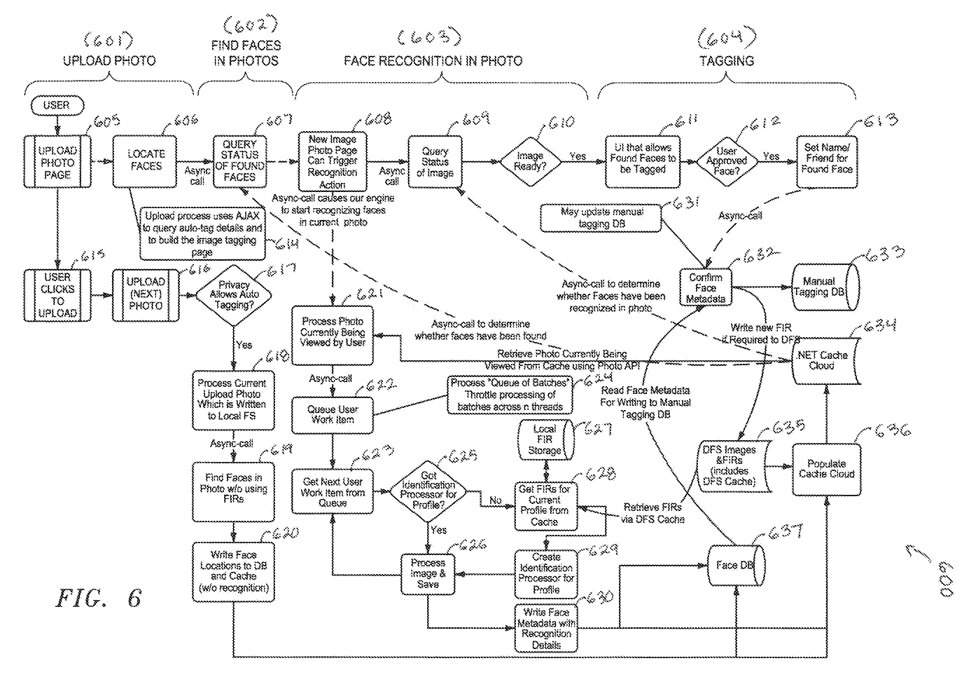

Thereafter, facial meta-data is appended to each processed photo (518), including a facial identification record which may be stored in a facial identification record storage system. Hereinafter, methodologies of automatic image tagging and associated storage elements are described with reference to FIGS. 6-8.

FIG. 6 illustrates a detailed methodology for automatic tagging of photographs/images. As illustrated, the processing and automatic tagging of photos is facilitated through four (4) stages of uploading photographs (601), locating/finding faces/people in the uploaded photographs (602), facial/feature recognition of the identified faces/people (603), and automatic tagging of the uploaded photos (604). These stages are described more fully below.

The method 600 includes uploading a photo or a plurality of photos on an image hosting website at blocks 605, 615, and 616. Thereafter, the method 600 includes locating faces within the uploaded photo (606) and querying a status of located faces at block 607. Thereafter, facial recognition is triggered at block 608 and the status of the image is queried at block 609. If the image is ready for automatic tagging (610), the image is presented to a user through a user interface, with proposed tags at block 611. If the user approves the tags (612), the tags are set for the image at block 613.

Privacy settings may also be implemented for a user's account, to determine if a user desires to utilize the automatic tagging features described above. Therefore, it may be determined if privacy settings allow automatic tagging at block 617. This may be omitted, however.

With regards to image processing, the method 600 may include separation depending upon a desired implementation. For example, image processing may be performed on a current or selected photo that has been uploaded at block 621. Alternatively, image processing may occur upon upload by the user at block 617.

With regards to a current or selected photo, the method may include processing the current photo at block 621. The photo may be queued as described in FIGS. 4-5. For example, blocks 622-630 may proceed as described with reference to FIG. 5. Therefore, exhaustive description is omitted for the sake of brevity. Thereafter, a cache cloud is populated (636), and the method continues as described above at block 609.

With regards to processing a photo upon upload, the method 500 includes processing an uploaded photo at block 618. Faces are identified in the photo at block 619, and identified face locations are written at block 620. Thereafter, a cache cloud is populated (636), and the method continues as described above at block 609.

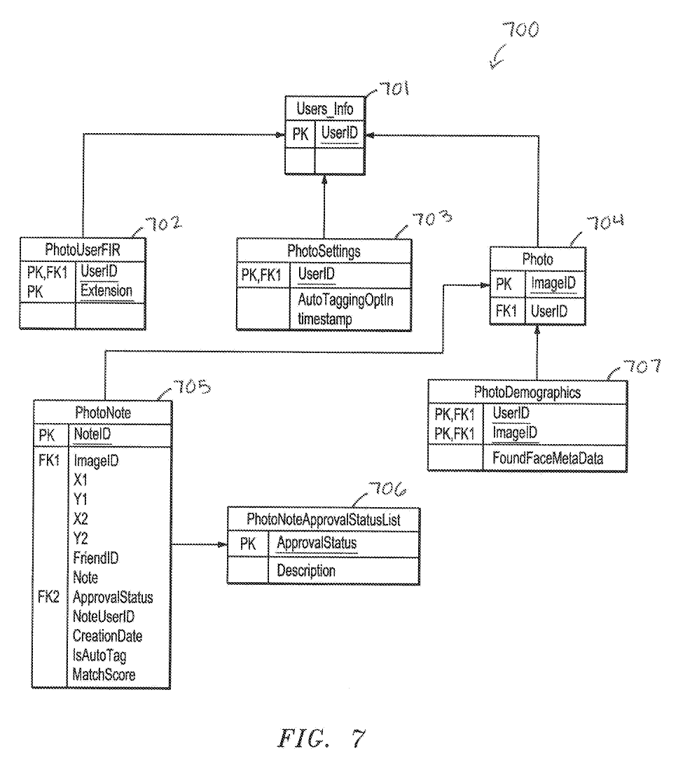

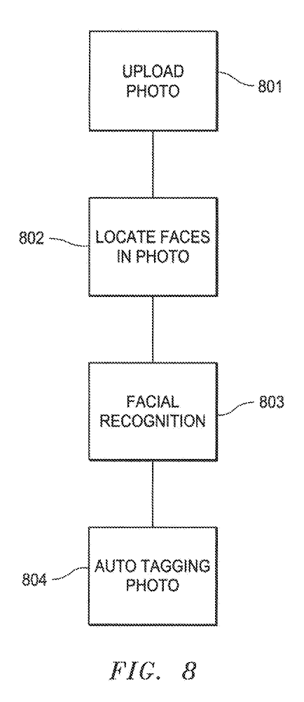

Alternatively, a user may desire to manually tag the photo or portions of a photo (631). The method 500 further includes confirming meta-data for identified and manually tagged faces at block 632, and updating a manual tagging database 633. It is noted that the manual tagging data base may also be updated based on user approved automatic tags as described with reference to blocks 612-613 above. Hereinafter, a database organization scheme for automatic tagging of photos, and a basic method of automatic tagging is described with reference to FIGS. 7-8.

FIG. 7 illustrates a database organization scheme 700 for automatic tagging of photographs/images. As illustrated, the meta-data for any uploaded/stored photo may include a plurality of data portions/variables including privacy settings, demographics, FIRs, notes/summaries, user ID for owner of photographs, and/or tags and image Ids.

For example, user information may be stored as item 701, which is dynamically linked to a facial identification record 702 of the user, photo settings or desired defaults of the user 703, and a photo(s) of the user 704. The photo(s) 704 may be linked to a photo note 705, which may include appropriate information including meta-data, captions, tags, and other information associated with the photo. The photo note 705 may also be linked to approval status of information associated with the photo 706. For example, if a user has not approved the tags of the photo, the approval status 706 may reflect this. Furthermore, demographics 707 of the photo may also be linked.

FIG. 8 illustrates a methodology for automatic tagging of photographs/images, according to an example embodiment. The method 800 may include uploading a photo at block 801. Uploading may include user interaction with a user device such that a photo or image stored or allocated on the user device is transmitted to an image hosting/social networking website or a processing system as described herein, which may reference user identification records 701.

The method 800 further includes locating faces/people in the uploaded photographs at block 802.

The method 800 further includes facial/feature recognition for the located faces/people at block 803.

And finally, the method 800 may include automatic tagging of the uploaded photographs at block 804.

It is noted that the tagging may also be facilitated through user interaction, manual tagging, tag matching in stored photo albums owned by the uploading user, or by any other suitable means.

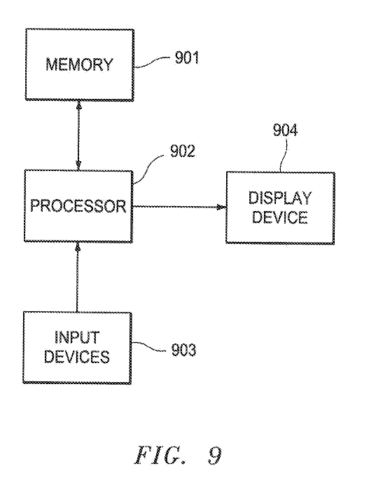

Furthermore, according to an exemplary embodiment, the methodologies described hereinbefore may be implemented by a computer system or apparatus. For example, FIG. 9 illustrates a computer apparatus, according to an exemplary embodiment. Therefore, portions or the entirety of the methodologies described herein may be executed as instructions in a processor 902 of the computer system 900. The computer system 900 includes memory 901 for storage of instructions and information, input device(s) 903 for computer communication, and display device 904. Thus, the present invention may be implemented, in software, for example, as any suitable computer program on a computer system somewhat similar to computer system 900. For example, a program in accordance with the present invention may be a computer program product causing a computer to execute the example methods described herein.

The computer program product may include a computer-readable medium having computer program logic or code portions embodied thereon for enabling a processor (e.g., 902) of a computer apparatus (e.g., 900) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body.

Further, such programs, when recorded on computer-readable storage media, may be readily stored and distributed. The storage medium, as it is read by a computer, may enable the method(s) disclosed herein, in accordance with an exemplary embodiment of the present invention.

Therefore, the methodologies and systems of example embodiments of the present invention can be implemented in hardware, software, firmware, or a combination thereof. Embodiments may be implemented in software or firmware that is stored in a memory and that is executed by a suitable instruction execution system. These systems may include any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of at least one example embodiment of the present invention in which functions may be executed out of order from that shown or discussed, including substantially concurrently or in reverse order, depending on the functionality involved, as would be understood by those reasonably skilled in the art of the present invention.

Any program which would implement functions or acts noted in the figures, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method of automatic tagging of images on an image hosting website, comprising:
receiving at least one image;
locating faces and/or people in the received image;
recognizing features of the located faces and/or people; and
automatically tagging the located faces and/or people in response to the recognizing.

2. The method of claim 1, wherein uploading at least one image includes:
accessing the image hosting website;
selecting the at least one image at a computer apparatus in operative communication with the image hosting website; and
uploading the at least one image, from the computer apparatus, to the image hosting website.

3. The method of claim 2, wherein the computer apparatus is a personal digital assistant (PDA), a personal computer, a cellular telephone, a notebook computer, or a portable computing device.

4. The method of claim 1, wherein further comprising:
retrieving image tag information associated with a user owning the received image;
generating a cropped image stream of the received image for each tag associated with the image tag information;
identifying locations of faces within the cropped image stream; and
generating a facial identification record (FIR) for each identified location.

5. The method of claim 4, further comprising:
retrieving image tag information associated with a user owning a plurality of uploaded images;
generating cropped image streams of each uploaded image for each tag associated with respective image tag information;
identifying locations of faces within the cropped image streams; and
generating a facial identification record (FIR) for each identified location.

6. The method of claim 1, wherein locating the faces and/or people includes:
retrieving image tag information associated with a user owning the received image;
generating a cropped image stream of the received image for each tag associated with the image tag information; and
identifying locations of faces within the cropped image stream.

7. The method of claim 1, wherein locating features of the located faces and/or people includes:
generating a FIR for each located face.

8. The method of claim 1, wherein automatically tagging the located faces and/or people includes:
providing proposed tags and locations of faces to a user owning the received image through a user interface; and
receiving an approval status for each proposed tag and location from the user.

9. The method of claim 1, further comprising:
notifying a distribution server of the received image;
determining a processing capacity of a recognition server in operative communication with the image hosting website in response to the notifying;
queuing processing of the received image at the recognition server in response to the determining.

10. The method of claim 9, wherein determining the processing capacity of the recognition server includes accessing a work item queue size of the recognition server, the work item queue size being directly related to both currently processing images and queued images for processing.

11. The method of claim 9, wherein if the received image is a first in a series of uploaded images from a user owning the uploaded images, determining a capacity of a drone recognition server, the drone recognition server being a back up recognition server disposed to handle image processing distributed from a central image processing distribution server.

12. The method of claim 9, wherein if the received image is not the first in a series of uploaded images from a user owning the uploaded images, queuing processing of the uploaded image to a drone recognition server already processing the series of uploaded images.

13. A system of automatic tagging of images on an image hosting website, comprising:
a user terminal;
the image hosting website in operative communication with the user terminal, the image hosting website disposed to receive images uploaded from the user terminal;
a recognition server in operative communication with the image hosting website, the recognition server disposed to receive images from the image hosting website and to process and automatically tag the received images; and
an image upload server in operative communication with the image hosting website, the image upload server disposed to store automatically tagged images received from the image hosting website.

14. The system of claim 13, wherein the recognition server includes:
a distribution server in operative communication with the image hosting website, the distribution server disposed to distribute images received from the image hosting website; and
a plurality of drone recognition servers in operative communication with the distribution server, each drone recognition server configured to process, locate, and recognize facial features of images received from the distribution server.

15. The system of claim 13, further comprising a FIR database in operative communication with the recognition server, the FIR database disposed to store a plurality of facial identification records associated with the images received from the image hosting website.

16. The system of claim 13, wherein the recognition server is disposed to implement a method, comprising:
locating faces and/or people in an image received from the image hosting website; and
recognizing features of the located faces and/or people.

17. A computer readable storage medium containing computer executable instructions that, if executed by a computer processor of a computer apparatus, direct the computer processor to implement a method of automatic tagging of images on an image hosting website, the method comprising:
receiving at least one image;
locating faces and/or people in the received image;
recognizing features of the located faces and/or people; and
automatically tagging the located faces and/or people in response to the recognizing.

18. The computer readable storage medium of claim 17, wherein the method further comprises:
retrieving image tag information associated with a user owning the received image;
generating a cropped image stream of the received image for each tag associated with the image tag information;
identifying locations of faces within the cropped image stream; and
generating a facial identification record (FIR) for each identified location.

19. The computer readable storage medium of claim 18, wherein the method further comprises:
retrieving image tag information associated with a user owning a plurality of uploaded images;
generating cropped image streams of each uploaded image for each tag associated with respective image tag information;
identifying locations of faces within the cropped image streams; and
generating a facial identification record (FIR) for each identified location.

20. The computer readable storage medium of claim 17, wherein locating the faces and/or people includes:
retrieving image tag information associated with a user owning the received image;
generating a cropped image stream of the received image for each tag associated with the image tag information; and
identifying locations of faces within the cropped image stream.
